(19) United States
(12) Patent Application Publication
(10) Pub. No.: US 2024/0311564 A1
(43) Pub. Date: Sep. 19, 2024

(54) TEXT PROCESSING METHOD AND APPARATUS, AND ELECTRONIC DEVICE

(71) Applicant: BEIJING ZITIAO NETWORK TECHNOLOGY CO.,LTD., Beijing (CN)

(72) Inventors: Yuxin Jing, Beijing (CN); Kai Ma, Beijing (CN); Zijia Chen, Beijing (CN); Xiao Wang, Beijing (CN); Feng Wang, Beijing (CN); Jiangwei Liu, Beijing (CN)

(21) Appl. No.: 18/570,970

(22) PCT Filed: Aug. 16, 2022
(86) PCT No.: PCT/CN2022/112785

§ 371 Date: Dec. 15, 2023

(30) Foreign Application Priority Data
Aug. 24, 2021 (CN) 202110978280.3

(51) Int. Cl. G06F 40/279; G06F 3/04817; G06F 16/38; G06F 40/30

(52) U.S. Cl. CPC G06F 40/279; G06F 16/38; G06F 40/30; G06F 3/04817

(57) ABSTRACT

Embodiments of the disclosure disclose a text processing method and apparatus, and an electronic device. A specific embodiment of the method includes: obtaining text to be processed, determining target entity words in the text to be processed, thereby generating a target entity word set; determining a word explanation corresponding to the target entity word in the target entity word set based on the text to be processed, and obtaining related information corresponding to the word explanation; and pushing target information to present the text to be processed, and displaying the target entity word in the target entity word set in a preset display mode in the text to be processed, where the target information includes the target entity word set, the word explanation corresponding to the target entity word in the target entity word set, and the related information.

### CROSS-REFERENCE TO RELATED APPLICATION(S)

This application is a U.S. National Stage Application of PCT Application Serial No. PCT/CN2022/112785, filed on Aug. 16, 2022, which claims the priority to Chinese patent application No. 202110978280.3, filed on Aug. 24, 2021 and entitled “Text processing method and apparatus, and electronic device”, the disclosures of which are incorporated in their entirety herein by reference.

### FIELD

Embodiments of the disclosure relate to the technical field of computers, and particularly relate to a text processing method and apparatus, and an electronic device.

### BACKGROUND

Instant messaging (IM) software, document editing applications, e-mail applications and other carriers that exchange information in the form of text generally involve various abbreviations, product terms, project terms, enterprise-specific words and other terms. These words can be referred to as entity words. Most of entity words belong to some specific subject fields, which possibly bring some difficulties to users' understanding of text.

### SUMMARY

The summary of the disclosure is provided to introduce concepts in a simplified way, and the concepts will be described in detail in the following detailed description of embodiments. The summary is intended neither to identify key features or essential features of the claimed technical solution nor limit the scope of the claimed technical solution.

Embodiments of the disclosure provide a text processing method and apparatus, and an electronic device, such that a user may quickly locate an entity word in text.

In a first aspect, an embodiment of the disclosure provides a text processing method. The method includes: obtaining text to be processed, and determining a target entity word in the text to be processed, thereby generating a target entity word set; determining a word explanation corresponding to the target entity word in the target entity word set based on the text to be processed, and obtaining related information corresponding to the word explanation; and pushing target information to present the text to be processed, and displaying the target entity word in the target entity word set in a preset display mode in the text to be processed. where the target information includes the target entity word set, the word explanation corresponding to the target entity word in the target entity word set, and the related information.

In a second aspect, an embodiment of the disclosure provides a text processing apparatus. The apparatus includes: an obtaining unit configured to obtain text to be processed. and determine a target entity word in the text to be processed, thereby generating a target entity word set; a determination unit configured to determine a word explanation corresponding to the target entity word in the target entity word set based on the text to be processed, and obtain related information corresponding to the word explanation; and a pushing unit configured to push target information to present the text to be processed, and display the target entity word in the target entity word set in a preset display mode in the text to be processed, where the target information includes the target entity word set, the word explanation corresponding to the target entity word in the target entity word set, and the related information.

In a third aspect, an embodiment of the disclosure provides an electronic device. The electronic device includes: one or more processors; and a storage apparatus configured to store one or more programs. When the one or more programs are executed by the one or more processors, the one or more processors is caused to implement the text processing method according to the first aspect.

In a fourth aspect, an embodiment of the disclosure provides a computer-readable medium that stores a computer program. The computer program implements the steps of the text processing method according to the first aspect when executed by a processor.

According to the text processing method and apparatus, and the electronic device, the text to be processed is obtained, a target entity word in the text to be processed is determined, thereby the target entity word set is generated; then, the word explanation corresponding to the target entity word in the target entity word set is determined based on the text to be processed. and the related information corresponding to the word explanation is obtained; and finally, the target information is pushed to present the text to be processed, and the target entity word in the target entity word set is displayed in a preset display mode in the text to be processed.

### BRIEF DESCRIPTION OF THE DRAWINGS

The above and other features, advantages and aspects of embodiments of the disclosure will become more obvious with reference to the following specific embodiments in conjunction with the accompanying drawings. In the drawings, the same or similar reference numerals denote the same or similar elements. It should be understood that the drawings are illustrative, and components and elements are not necessarily drawn to scale.

FIG. 1 is an illustrative diagram of a system architecture in which embodiments of the disclosure may be applied;

FIG. 2 is a flow diagram of an embodiment of a text processing method according to the disclosure;

FIG. 3 is a schematic diagram of a presentation mode of text to be processed in the text processing method according to the disclosure;

FIG. 4 is a schematic diagram of a word card corresponding to an entity word in the text processing method according to the disclosure;

FIG. 5 is a flow diagram of an embodiment of updating an entity word recognition model in the text processing method according to the disclosure;

FIG. 6 is a flow diagram of an embodiment of determining a word explanation corresponding to an entity word in the text processing method according to the disclosure;

FIG. 7 is a flow diagram of another embodiment of determining a word explanation corresponding to an entity word in the text processing method according to the disclosure;

FIG. 8 is a schematic structural diagram of an embodiment of a text processing apparatus according to the disclosure; and

FIG. 9 is a schematic structural diagram of a computer system suitable for implementing an electronic device according to embodiments the disclosure.

### DETAILED DESCRIPTION OF EMBODIMENTS

Embodiments of the disclosure will be described in more detail below with reference to the accompanying drawings. Although some embodiments of the disclosure are shown in the accompanying drawings, it should be understood that the disclosure may be implemented in various forms and should not be construed as being limited to the embodiments illustrated herein. On the contrary, the embodiments are provided for a more thorough and complete understanding of the disclosure. It should be understood that the drawings and the embodiments of the disclosure are only for illustrative purposes, instead of limiting the protection scope of the disclosure.

It should be understood that all steps described in method embodiments of the disclosure may be executed in a different order and/or in parallel. Further, the method embodiments may include additional steps and/or omit execution of the illustrated steps, which do not limit the scope of the disclosure.

The terms “include” and “comprise” used herein and their variations are open-ended, that is, “including but not limited to” and “comprising but not limited to”. The term “based on” means “at least partly based on”. The term “an embodiment” means “at least one embodiment”. The term “another embodiment” means “at least another embodiment”. The term “some embodiments” means “at least some embodiments”. Related definitions of other terms will be given in the following description.

It should be noted that concepts such as “first” and “second” mentioned in the disclosure are only used to distinguish different apparatuses, modules or units, and are not used to limit an order or interdependence of functions executed by the apparatuses, modules or units.

It should be noted that modification with “a”, “an” or “a plurality of” mentioned in the disclosure is illustrative rather than limitative, and should be understood by those skilled in the art as “one or more” unless explicitly stated otherwise in the context.

Names of messages or information exchanged between a plurality of apparatuses in the embodiment of the disclosure are only for illustrative purposes, instead of limiting the scope of the messages or information.

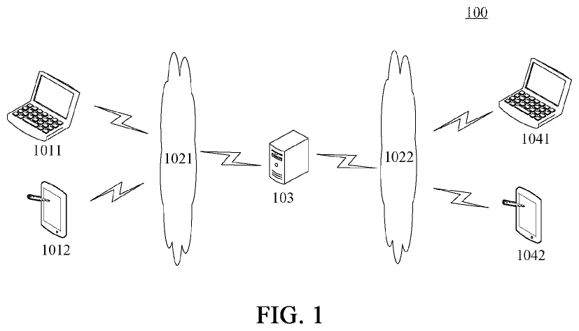

FIG. 1 shows an illustrative diagram of a system architecture 100 in which an embodiment of a text processing method according to the disclosure may be applied.

As shown in FIG. 1, the system architecture 100 may include terminal devices 1011 and 1012, networks 1021 and 1022, a server 103, and presentation terminal devices 1041 and 1042. The network 1021 is configured to provide the medium of communication links between the terminal devices 1011 and 1012 and the server 103. The network 1022 is configured to provide the medium of communication links between the server 103 and the presentation terminal devices 1041 and 1042. The networks 1021 and 1022 may have various connection types, such as a wired or wireless communication link or a fiber optic cable.

A user may interact with the server 103 through the network 1021 with the terminal devices 1011 and 1012, and transmit or receive a message. For example, the user may transmit text to be processed to the server 103 with the terminal devices 1011, 1012 and 1013. The user may interact with the server 103 through the network 1022 with the presentation terminal devices 1041 and 1042, and transmit or receive a message. For example, the server 103 may transmit content to be corrected to the presentation terminal devices 1041 and 1042. The terminal devices 1011 and 1012 and the presentation terminal devices 1041 and 1042 may be configured with various communication client applications, such as instant messaging software, a document editing application, and a mailbox application.

The terminal devices 1011 and 1012 may be hardware or software. When the terminal devices 1011 and 1012 are hardware, the terminal devices may be various electronic devices having display screens and supporting information interaction, which include, but are not limited to, smart phones, tablet computers, laptop computers, etc. When the terminal devices 1011 and 1012 are software, the terminal devices may be installed in the electronic devices listed above. The terminal devices may be implemented as a plurality of pieces of software or software modules (for example, a plurality of pieces of software or software modules configured to provide distributed services), or a single piece of software or a single software module, which will not be specifically limited herein.

The presentation terminal devices 1041 and 1042 may be hardware or software. When the presentation terminal devices 1041 and 1042 are hardware, the presentation terminal devices may be various electronic devices having display screens and supporting information interaction, which include, but are not limited to, smart phones, tablet computers, laptop computers, etc. When the presentation terminal devices 1041 and 1042 are software, the presentation terminal devices may be installed in the electronic devices listed above. The presentation terminal devices may be implemented as a plurality of pieces of software or software modules (for example, a plurality of pieces of software or software modules configured to provide distributed services), or a single piece of software or a single software module, which will not be specifically limited herein.

The server 103 may be a server that provides various services. For example, the server 103 may obtain text to be processed from the terminal devices 1011 and 1012, determine a target entity word in the text to be processed, thereby generating a target entity word set. Then, the server 103 may determine a word explanation corresponding to the target entity word in the target entity word set based on the text to be processed, and obtain related information corresponding to the word explanation. Finally, the server 103 may push target information to the terminal devices 1011 and 1012 and the presentation terminal devices 1041 and 1042, to present the text to be processed, and display the target entity word in the target entity word set in a preset display mode in the text to be processed, where the target information includes the target entity word set, the word explanation corresponding to the target entity word in the target entity word set, and the related information.

It should be noted that the server 103 may be hardware or software. When the server 103 is hardware, the server may be implemented as a distributed server cluster composed of a plurality of servers or a single server. When the server 103 is software, the server may be implemented as a plurality of pieces of software or software modules (for example, software or software modules configured to provide distributed services) or a single piece of software or a single software module, which will not be specifically limited herein.

It should be further noted that a text processing method according to an embodiment of the disclosure is generally executed by the server 103. In this case, a text processing apparatus is generally configured in the server 103.

It should be understood that the number of terminal devices, the number of networks, the number of servers and the number of presentation terminal devices in FIG. 1 are only illustrative. The number of terminal devices, the number of networks, the number of servers and the number of presentation terminal devices may be any numbers as required in an implementation.

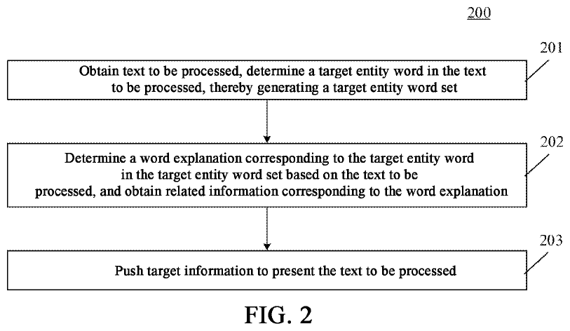

Further, FIG. 2 shows a flow 200 of an embodiment of a text processing method according to the disclosure. The text processing method includes the following steps:

Step 201, text to be processed is obtained, a target entity word in the text to be processed is determined, thereby a target entity word set is generated.

In the embodiment, the execution subject (for example, the server shown in FIG. 1) of the text processing method may obtain the text to be processed. The text to be processed may be text to be subjected to entity word filtering in a carrier for information exchange with text information, including, but not limited to, at least one of the following: text in instant messaging (IM) software, text in a document, and text in an e-mail.

Then, the execution subject may determine the target entity word in the text to be processed to generate the target entity word set. The target entity word may be an entity word to be specially displayed (for example, to be highlighted) in the text to be processed. The execution subject may specially display an entity word that satisfies a preset condition, and the condition may be set according to service needs. In this case, the entity words may include, but are not limited to, at least one of the following: abbreviations, product names, project names, enterprise-specific words, and terms.

Step 202, a word explanation corresponding to the target entity word in the target entity word set is determined based on the text to be processed, and related information corresponding to the word explanation is obtained.

In the embodiment, the execution subject may determine the word explanation corresponding to the target entity word in the target entity word set based on the text to be processed. The word explanation may also be referred to as a word paraphrase.

In this case, the execution subject may store a correspondence table of the correspondence between an entity word and a word explanation. For a target entity word in the target entity word set, the execution subject may look up the word explanation corresponding to the target entity word in the correspondence table. If the target entity word only corresponds to one word explanation, the execution subject may determine the found word explanation to be the word explanation corresponding to the target entity word. If the target entity word corresponds to at least two word explanations, the execution subject may input the text to be processed, the target entity word and at least two found word explanations into a pre-trained word explanation recognition model, and obtain the word explanation corresponding to the target entity word. The word explanation recognition model may be configured to characterize a correspondence between the text, the entity word in the text and the word explanation corresponding to the entity word.

Then, the execution subject may obtain related information corresponding to the word explanation. The related information may include, but is not limited to, at least one of the following: a title of a word-related document and a link name of a word-related link. If the target entity word is an English abbreviation, the related information may further include an English full name and a Chinese meaning.

Step 203, target information is pushed to present the text to be processed.

In the embodiment, the execution subject may push the target information to a target terminal. The target information may include the target entity word set, the word explanation corresponding to the target entity word in the target entity word set, and the related information. The target terminal may be a terminal that is about to present the text to be processed, and generally includes the execution subject and other user terminals except the execution subject. For example, if the text to be processed is dialogue text, the target terminal is generally a user terminal that is about to receive the dialogue text. If the text to be processed is text in a collaborative document, the target terminal is generally a user terminal that opens the collaborative document.

It should be noted that if the target terminal is a user terminal other than the user terminal that is the source of the text to be processed, the target information generally further includes the text to be processed.

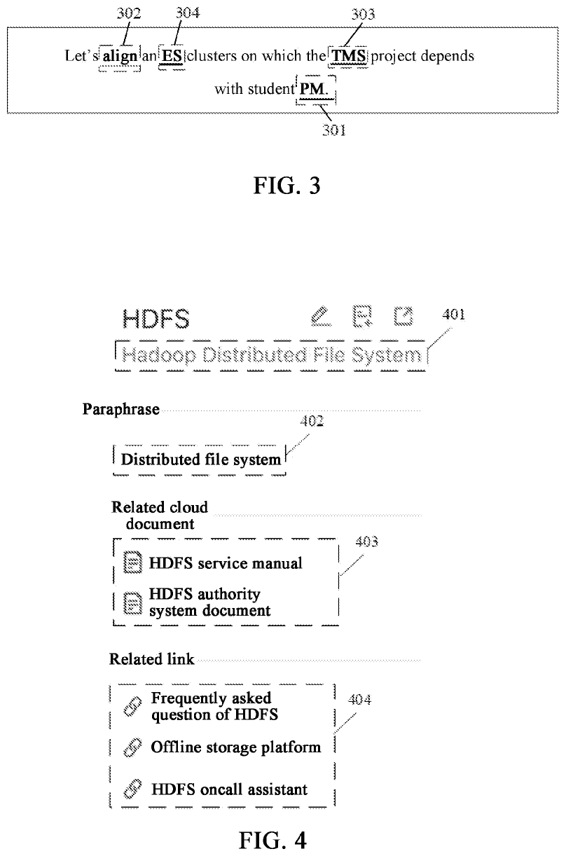

After receiving the target information, the target terminal may present the text to be processed. In this case, the target entity word in the target entity word set may be displayed in a preset display mode in the text to be processed. For example, the target entity word in the target entity word set may be displayed in display modes such as highlighting and bold display. FIG. 3 shows a schematic diagram of a presentation mode of the text to be processed in the text processing method. In FIG. 3, the text to be processed is “Let's align the ES clusters on which the TMS project depends with student PM”. In this case, the target entity words in the text to be processed are “PM”, “align”, “TMS”, and “ES”, as shown in reference numerals 301, 302, 303 and 304. The target entity words in the text to be processed are displayed in a bold and underlined display mode.

If a target terminal detects that a user executes a preset operation for a target entity word in text to be processed presented by the target terminal, such as a clicking operation and a mouse hovering operation, the target terminal may present a word card corresponding to the target entity word targeted by the operation, and the word card presents a word explanation of the target entity word targeted by the operation and related information. FIG. 4 shows a schematic diagram of a word card corresponding to an entity word in the text processing method. In FIG. 4, an entity word is “HDFS”, and the English full name of the entity word “HDFS” is a “Hadoop Distributed File System”, as shown in reference numeral 401. A paraphrase of the entity word “HDFS” is a “distributed file system”, as shown in reference numeral 402. The title of a related document of the entity word “HDFS” is as shown in reference numeral 403. The link names of related links of the entity word “HDFS” are as shown in reference numeral 404.

The entity word in the text to be processed may be specially displayed with the method according to the embodiment of the disclosure, such that the user may quickly locate the entity word in the text. If the user executes a preset operation for the entity word, a word explanation corresponding to the entity word may be presented, such that the user is prevented from jumping out of a current application for inquiry about the explanation of the entity word. In this way, operation steps of the user can be simplified, such that the user may quickly understand the entity word in the text to be processed, and interaction efficiency of the user can be improved.

In some alternative implementations, the execution subject may determine the target entity word in the text to be processed as follows: the execution subject may determine at least one candidate entity word in the text to be processed; and then the execution subject may obtain first target text. The first target text may be text adjacent to the text to be processed and before the text to be processed. For example, in instant messaging software, the first target text may be recent N dialogue turns; and in a document, the first target text may be recent M sentences. Then, the target entity word may be selected from the at least one candidate entity word based on the first target text. In this case, the execution subject may determine all candidate entity words in the at least one candidate entity word to be target entity words.

In some alternative implementations, the execution subject may determine the at least one candidate entity word in the text to be processed as follows: the execution subject may perform word segmentation on the text to be processed, and obtain a word segmentation result. The execution subject may perform word segmentation on the text to be processed in a Chinese word segmentation method, which will not be repeated herein. Then, the execution subject may look up an entity word matching the word segmentation result in a preset entity word set as the at least one candidate entity word. An entity word in the entity word set may be mined through manual lookup and verification, or may be recognized with a trained entity word recognition model. For each word in the word segmentation result, if the execution subject finds the word in the entity word set, the word may be determined to be the candidate entity word.

In some alternative implementations, the execution subject may determine the at least one candidate entity word in the text to be processed as follows: the execution subject may perform word segmentation on the text to be processed, and obtain a word segmentation result. For each word in the word segmentation result, the execution subject may obtain a word feature of the word. The word feature may include, but is not limited to, at least one of the following: a word name, a word alias, whether the word is an abbreviation, whether the word is an English word, whether the word is an abbreviation in English, whether the word is a common sense word, whether the word has a related document, and an N-Gram score of the word name in a common corpus (an external corpus).

It should be noted that the N-Gram score is a score that may be inferred and computed on input text (the entity word herein) based on an N-Gram language model, and represents a degree of commonness of an entity word in a certain corpus. A value of the score is negative. The smaller the value, the rarer the entity word is, for example, −100. The bigger the value, the more common the entity word is, for example, −1.0. Computation of the N-Gram score may be supported with a KenLM tool. First, a model is trained on a specified corpus, and then an entity word may be input into the trained model, such that a score is computed. In this case, a Chinese/English corpus of wikipedia may be used as an external corpus. Rarity of rare terms or enterprise-specific terms in each corpus may be effectively determined with the N-Gram language model, which facilitates determination of whether the entity word is a target entity word.

Then, the word feature of the word may be input into a pre-trained entity word recognition model, such that a recognition result of the word is obtained. The entity word recognition model may be configured to characterize a correspondence between the word feature of the word and the recognition result of the word. The recognition result may be used to indicate that the word is an entity word or used to indicate that the word is not an entity word. As an example, the recognition result “T” or “1” may indicate that the word is an entity word; and the recognition result “F” or “0” may indicate that the word is not an entity word.

If the recognition result indicates that the word is the entity word (for example, the recognition result is “T” or “1”), the word may be determined to be a candidate entity word.

In some alternative implementations, the execution subject may select the target entity word from the at least one candidate entity word based on the first target text as follows: for a candidate entity word in the at least one candidate entity word, the execution subject may determine whether the candidate entity word exists in the first target text, and if the candidate entity word does not exist in the first target text, the execution subject may determine the candidate entity word to be the target entity word. In this way, an entity word previously displayed may be not specially displayed, such that disturbance to the user is reduced, and reading experience of the user is improved.

In some alternative implementations, the text to be processed may be dialogue text in instant messaging software. The execution subject may select the target entity word from the at least one candidate entity word based on the first target text as follows: the execution subject may obtain text generation time of the first target text, that is, may obtain dialogue time of the last turn of dialogue; and then may determine whether duration (that is, an interval between dialogues) between the current time and the text generation time is shorter than a preset duration threshold (for example, 24 h); and if the duration is shorter than the duration threshold, for a candidate entity word in the at least one candidate entity word, the execution subject may determine whether the candidate entity word exists in the first target text, and if the candidate entity word does not exist in the first target text, the candidate entity word is determined to be the target entity word. In such a dialogue scene, when the interval between two turns of dialogues is short, the entity word previously displayed is not specially displayed; and when the interval between two turns of dialogues is long, the entity word previously displayed is specially displayed, such that whether the entity word is specially displayed may be flexibly adjusted according to actual needs.

In some alternative implementations, after determining whether the duration between the current time and the text generation time is shorter than the preset duration threshold, if the duration is longer than or equal to the duration threshold, the execution subject may determine the at least one candidate entity word to be the target entity word. In this way, when the interval between the two turns of dialogues in the dialogue scene is long. the entity word may be specially displayed regardless of whether the entity word appears in a previous dialogue or not.

In some alternative implementations, the execution subject may determine whether a similarity between each word explanation of at least two word explanations corresponding to the target entity word and the target entity word is smaller than a preset similarity threshold. If the similarity between each word explanation and the target entity word is smaller than the preset similarity threshold, the execution subject may delete the target entity word from the target entity word set, thereby obtaining a new target entity word set as the target entity word set. The target entity word in the new target entity word set is processed in subsequent processing (determining the word explanation corresponding to the target entity word, specially displaying the target entity word(s) in the text to be processed, etc.).

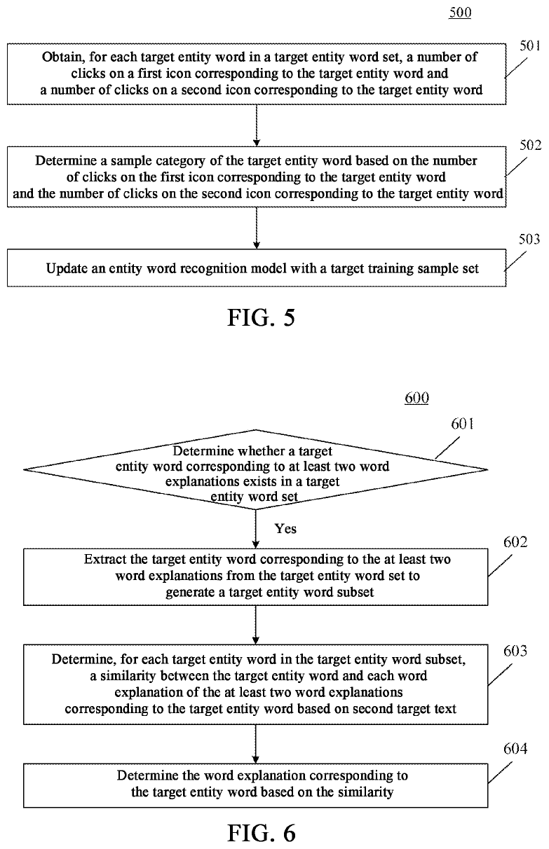

Further, FIG. 5 shows a flow 500 of an embodiment of updating an entity word recognition model in a text processing method. The flow 500 of updating an entity word recognition model includes the following steps:

Step 501, for each target entity word in a target entity word set, a number of clicks on a first icon corresponding to the target entity word and a number of clicks on a second icon corresponding to the target entity word are obtained.

In the embodiment, a presentation page (which may be the word card) of the word explanation may include the first icon and the second icon. The first icon may be used to indicate that a word indicated by the word explanation is an entity word. The first icon may be presented in a “like” form. The second icon may be used to indicate that a word indicated by the word explanation is not an entity word. The second icon may be presented in a “dislike” form. If a user clicks on the first icon in the presentation page, it may be understood that the user thinks that the word indicated by the word explanation is an entity word. If a user clicks on the second icon in the presentation page, it may be understood that the user thinks that the word indicated by the word explanation is not an entity word. In this way, a feedback channel of accuracy of entity words is provided for the user.

In the embodiment, for each target entity word in the target entity word set, an execution subject (for example, the server shown in FIG. 1) of the text processing method may obtain the number of clicks on the first icon corresponding to the target entity word (that is, the number of clicks on a “like” icon by the user) and the number of clicks on the second icon corresponding to the target entity word (that is, the number of clicks on a “dislike” icon by the user).

Step 502, a sample category of the target entity word is determined based on the number of clicks on the first icon corresponding to the target entity word and the number of clicks on the second icon corresponding to the target entity word.

In the embodiment, the execution subject may determine the sample category of the target entity word based on the number of clicks on the first icon corresponding to the target entity word and the number of clicks on the second icon corresponding to the target entity word. The sample category may include a positive sample and a negative sample.

As an example, if a ratio of the number of clicks on the first icon to the number of clicks on the second icon is greater than a first preset value (for example, 3), the execution subject may determine that the sample category of the target entity word is the positive sample. If a ratio of the number of clicks on the first icon to the number of clicks on the second icon is smaller than or equal to a first preset value, the execution subject may determine that the sample category of the target entity word is the negative sample.

As another example, if the number of clicks on the first icon is greater than a second preset value (for example, 20) and the number of clicks on the second icon is smaller than a third preset value (for example, 5), the execution subject may determine that the sample category of the target entity word is the positive sample. If the number of clicks on the first icon is smaller than or equal to a second preset value or the number of clicks on the second icon is greater than or equal to a third preset value, the execution subject may determine that the sample category of the target entity word is the negative sample.

Step 503, an entity word recognition model is updated with a target training sample set.

In the embodiment, the execution subject may update the entity word recognition model with the target training sample set. The target training sample may include the target entity word in the target entity word set and the sample category of the target entity word. Specifically, the target entity word in the target training sample set may be regarded as input of the entity word recognition model, and the sample category corresponding to the input target entity word may be regarded as output of the entity word recognition model, thereby updating the entity word recognition model.

According to the method of the embodiment of the disclosure, positive and negative feedback is collected through clicking operations by the user on the “like” icon and the “dislike” icon, such that a large number of positive and negative data samples are obtained for iterative upgrading training of the entity word recognition model, thereby the performance of the entity word recognition model is constantly improved, and recognition accuracy of the entity word recognition model is improved.

Further, FIG. 6 shows a flow 600 of an embodiment of determining a word explanation corresponding to an entity word in a text processing method. The flow 600 of determining the word explanation corresponding to the entity word includes the following steps:

Step 601, whether a target entity word corresponding to at least two word explanations exists in a target entity word set is determined.

In the embodiment, an execution subject (for example, the server shown in FIG. 1) of the text processing method may determine whether the target entity word corresponding to at least two word explanations exists in the target entity word set. In this case, the execution subject generally stores a correspondence table of the correspondence between an entity word and an word explanation. For a target entity word in the target entity word set, the execution subject may obtain the word explanation corresponding to the target entity word in the correspondence table, such that whether the target entity word corresponds to at least two word explanations exists is determined.

Step 602, if the target entity word corresponding to at least two word explanations exists in the target entity word set, the target entity word corresponding to at least two word explanations is extracted from the target entity word set to generate a target entity word subset.

In the embodiment, in response to determining that the target entity word corresponding to the at least two word explanations exists in the target entity word set in step 601, the execution subject may extract the target entity word corresponding to at least two word explanations from the target entity word set to generate the target entity word subset. That is, the execution subject may filter the target entity words in the target entity word set, and filter out the target entity word(s) corresponding to at least two word explanations to form the target entity word subset.

Step 603, for each target entity word in the target entity word subset, a similarity between the target entity word and each word explanation of the at least two word explanations corresponding to the target entity word is determined based on second target text.

In the embodiment, for each target entity word in the target entity word subset, the execution subject may determine the similarity between the target entity word and each word explanation of the at least two word explanations corresponding to the target entity word based on the second target text. The second target text may be text adjacent to the target entity word in the text to be processed. As an example, in instant messaging software, the second target text may be N turns of dialogues immediately before the target entity word and/or K turns of dialogues immediately after the target entity word. In a document, the second target text may be M dialogues immediately before the target entity word and/or I dialogues immediately after the target entity word.

In this case, for each word explanation of the at least two word explanations corresponding to the target entity word, the execution subject may input the second target text, the target entity word and the word explanation into a pre-trained similarity recognition model to obtain the similarity between the target entity word and the word explanation. In this case, the similarity recognition model may be configured to characterize the correspondence between a similarity between the entity word and the word explanation and the following three: the entity word, context of text where the entity word is located, and the word explanation.

Step 604, the word explanation corresponding to the target entity word is determined based on the similarity.

In the embodiment, the execution subject may determine the word explanation corresponding to the target entity word based on the similarity obtained in step 603. In this case, the execution subject may select a word explanation having a maximum similarity from the at least two word explanations corresponding to the target entity word as the word explanation corresponding to the target entity word.

According to the method of the embodiment of the disclosure, when the entity word corresponds to at least two word explanations, the word explanation matching current context of the text where the entity word is located is determined from the at least two word explanations, such that the presented word explanation is more rational and more in line with the current context.

In some alternative implementations, the execution subject may further determine the similarity between the target entity word and each word explanation of the at least two word explanations corresponding to the target entity word based on the second target text as follows: the execution subject may perform semantic encoding on the second target text to obtain a first semantic vector. As an example, the execution subject may perform sparse vector encoding (One-Hot encoding), dense vector encoding (encoding based on pre-training models such as bidirectional encoder representations from transformers (BERT)) and robustly optimized BERT approach (RoBERTa), or other semantic encoding on the second target text to obtain the first semantic vector. For each word explanation of the at least two word explanations corresponding to the target entity word, the execution subject may perform semantic encoding on the word explanation to obtain a second semantic vector. As an example, the execution subject may perform sparse vector encoding, dense vector encoding, or other semantic encoding on the word explanation to obtain the second semantic vector. Then, a similarity between the first semantic vector and the second semantic vector may be determined to as the similarity between the target entity word and the word explanation. In this case, the execution subject may determine the similarity between the first semantic vector and the second semantic vector with a pre-established binary classification full neural network.

In some alternative implementations, the execution subject may further determine the similarity between the target entity word and each word explanation of the at least two word explanations corresponding to the target entity word based on the second target text as follows: the execution subject may extract a preset number of words adjacent to the target entity word from the text to be processed as target words. For example. N words immediately before the target entity word and/or M words immediately after the target entity word may be extracted from the text to be processed. For each word explanation of the at least two word explanations corresponding to the target entity word, the execution subject may perform coincidence matching on the word explanation and the target words. That is, word co-occurrence matching is performed. Then, a ratio of the number of coincident words to the number of the target words (for example, N+M) may be determined as the similarity between the target entity word and the word explanation. In this case, the greater the number of co-occurring words in the word explanation and in the target words, the greater the similarity between the target entity word and the word explanation is.

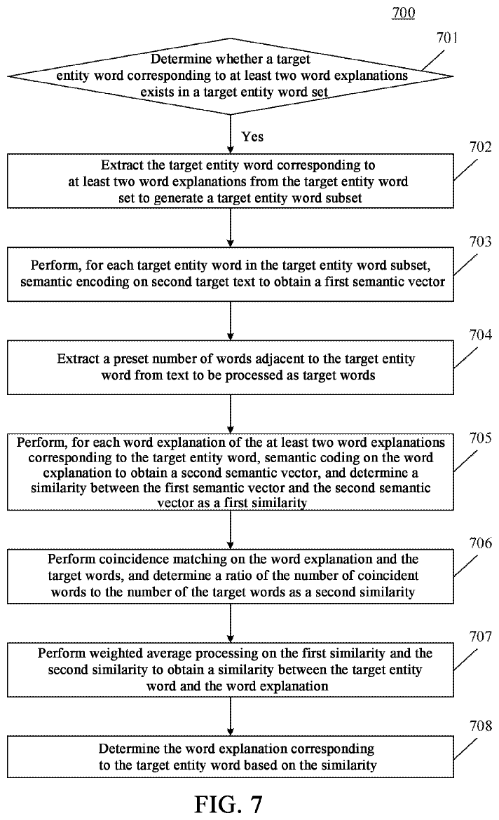

Further, FIG. 7 shows a flow 700 of another embodiment of determining a word explanation corresponding to an entity word in a text processing method. The flow 700 of determining the word explanation corresponding to the entity word includes the following steps:

Step 701, whether a target entity word corresponding to at least two word explanations exists in a target entity word set is determined.

Step 702, if the target entity word corresponding to at least two word explanations exists in the target entity word set, the target entity word corresponding to at least two word explanations is extracted from the target entity word set to generate a target entity word subset.

In the embodiment, steps 701-702 may be executed in a manner similar to steps 601-602, which will not be repeated herein.

Step 703, for each target entity word in the target entity word subset, semantic encoding is performed on second target text to obtain a first semantic vector.

In the embodiment, for each target entity word in the target entity word subset, an execution subject (for example, the server shown in FIG. 1) of the text processing method may perform semantic encoding on the second target text to obtain the first semantic vector.

As an example, the execution subject may perform sparse vector encoding, dense vector encoding, or other semantic encoding on the second target text to obtain the first semantic vector.

As another example, the execution subject may further input the second target text into a pre-trained semantic recognition model to obtain a semantic vector of the second target text as the first semantic vector.

Step 704, a preset number of words adjacent to the target entity word are extracted from text to be processed as target words.

In the embodiment, the execution subject may extract the preset number of words adjacent to the target entity word from the text to be processed as the target words. For example, N words immediately before the target entity word and/or M words immediately after the target entity word may be extracted from the text to be processed.

Step 705, for each word explanation of the at least two word explanations corresponding to the target entity word, semantic encoding is performed on the word explanation to obtain a second semantic vector, and a similarity between the first semantic vector and the second semantic vector is determined as a first similarity.

In the embodiment, for each word explanation of the at least two word explanations corresponding to the target entity word, the execution subject may perform semantic encoding on the word explanation to obtain the second semantic vector.

As an example, the execution subject may perform sparse vector encoding, dense vector encoding, or other semantic encoding on the word explanation to obtain the second semantic vector.

As another example, the execution subject may further input the word explanation into a pre-trained semantic recognition model to obtain a semantic vector of the word explanation as the second semantic vector.

Then, a similarity between the first semantic vector and the second semantic vector may be determined as the similarity between the target entity word and the word explanation. In this case, the execution subject may determine the similarity between the first semantic vector and the second semantic vector with a pre-established binary classification full neural network.

Step 706, coincidence matching is performed on the word explanation and the target words, and a ratio of the number of coincident words to the number of the target words is determined as a second similarity.

In the embodiment, the execution subject may perform coincidence matching on the word explanation and the target words. That is, word co-occurrence matching is performed. Then, the ratio of the number of coincident words to the number of the target words (for example, N+M) may be determined as the similarity between the target entity word and the word explanation. In this case, the greater the number of co-occurring words in the word explanation and in the target words, the greater the similarity between the target entity word and the word explanation is.

Step 707, weighted average processing is performed on the first similarity and the second similarity to obtain a similarity between the target entity word and the word explanation.

In the embodiment, the execution subject may perform weighted average processing on the first similarity determined in step 705 and the second similarity determined in step 706, thereby obtaining the similarity between the target entity word and the word explanation. In this case, weights corresponding to the first similarity and the second similarity may be set according to actual needs.

Step 708, the word explanation corresponding to the target entity word is determined based on the similarity.

In the embodiment, step 708 may be executed in a manner similar to step 604, which will not be repeated herein.

As may be seen from FIG. 7, compared with the embodiment corresponding to FIG. 6, the flow 700 of determining the word explanation corresponding to the entity word in the text processing method in the embodiment illustrate steps of determining the similarity through semantic encoding and the similarity through word co-occurrence, thereby determining the word explanation corresponding to the entity word. In this way, the solution described in the embodiment can more accurately determine the similarity between the entity word and the word explanation.

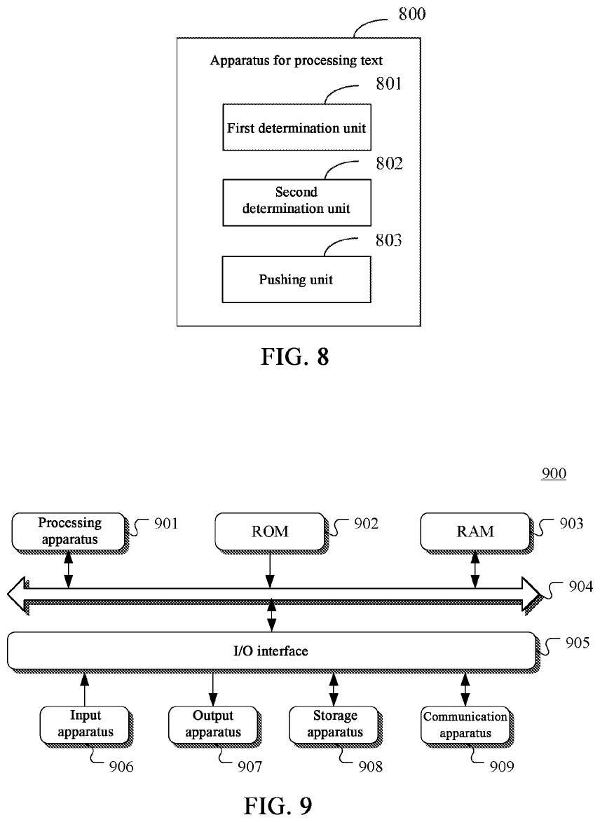

Further, with reference to FIG. 8, the disclosure provides an embodiment of a text processing apparatus so as to implement the methods shown in the above figures. The apparatus embodiment corresponds to the method embodiment shown in FIG. 2. The apparatus may be specifically applied to various electronic devices.

As shown in FIG. 8, the apparatus 800 for processing text according to the embodiment includes: a first determination unit 801, a second determination unit 802, and a pushing unit 803. The first determination unit 801 is configured to obtain text to be processed, determine the target entity word in the text to be processed, thereby generating a target entity word set. The second determination unit 802 is configured to determine a word explanation corresponding to the target entity word in the target entity word set based on the text to be processed, and obtain related information corresponding to the word explanation. The pushing unit 803 is configured to push target information to present the text to be processed, and display the target entity word in the target entity word set in a preset display mode in the text to be processed, where the target information includes the target entity word set, the word explanation corresponding to the target entity word in the target entity word set.

In the embodiment, reference may be made to step 201, step 202 and step 203 in the embodiment corresponding to FIG. 2 for specific processing of the first determination unit 801, the second determination unit 802 and the pushing unit 803 of the apparatus 800 for processing text.

In some alternative implementations, the first determination unit 801 may be further configured to determine the target entity word in the text to be processed as follows: the first determination unit 801 may determine at least one candidate entity word in the text to be processed; and then may obtain first target text, and select the target entity word from the at least one candidate entity word based on the first target text. The first target text is text adjacent to the text to be processed and before the text to be processed.

In some alternative implementations, the first determination unit 801 may be further configured to determine the at least one candidate entity word in the text to be processed as follows: the first determination unit 801 may perform word segmentation on the text to be processed to obtain a word segmentation result; and then may look up an entity word matching the word segmentation result in a preset entity word set as the at least one candidate entity word.

In some alternative implementations, the first determination unit 801 may be further configured to determine the at least one candidate entity word in the text to be processed as follows: the first determination unit 801 may perform word segmentation on the text to be processed to obtain a word segmentation result; and then may obtain, for each word in the word segmentation result, a word feature of the word, input the word feature of the word into a pre-trained entity word recognition model, obtain a recognition result of the word, and determine, if the recognition result indicates that the word is an entity word, the word to be a candidate entity word. The recognition result is used to indicate that the word is the entity word or to indicate that the word is not an entity word.

In some alternative implementations, a presentation page of the word explanation may include a first icon and a second icon. The first icon may be used to indicate that the word indicated by the word explanation is an entity word. The second icon may be used to indicate that the word indicated by the word explanation is not an entity word. The apparatus 800 for processing text may further include: an obtaining unit (not shown in the figure), a third determination unit (not shown in the figure), and an updating unit (not shown in the figure). For each target entity word in the target entity word set, the obtaining unit may obtain a number of clicks on a first icon corresponding to the target entity word and a number of clicks on a second icon corresponding to the target entity word; the third determination unit may determine a sample category of the target entity word based on the number of clicks on the first icon corresponding to the target entity word and the number of clicks on the second icon corresponding to the target entity word, where the sample category includes a positive sample and a negative sample; and the updating unit may update the entity word recognition model with a target training sample set, where a target training sample includes the target entity word in the target entity word set and the sample category of the target entity word.

In some alternative implementations, the first determination unit 801 may be further configured to select the target entity word from the at least one candidate entity word based on the first target text as follows: for a candidate entity word in the at least one candidate entity word, the first determination unit 801 may determine the candidate entity word to be the target entity word in response to determining that the candidate entity word does not exist in the first target text.

In some alternative implementations, the text to be processed is dialogue text. The first determination unit 801 may be further configured to select the target entity word from the at least one candidate entity word based on the first target text as follows: the first determination unit 801 may obtain text generation time of the first target text; and then may determine whether duration between the current time and the text generation time is shorter than a preset duration threshold; and if so, for a candidate entity word in the at least one candidate entity word, the first determination unit 801 may determine the candidate entity word to be the target entity word in response to determining that the candidate entity word does not exist in the first target text.

In some alternative implementations, the apparatus 800 for processing text may further include: a fourth determination unit (not shown in the figure). If the duration is longer than or equal to the duration threshold, the fourth determination unit may determine the at least one candidate entity word to be the target entity word.

In some alternative implementations, the second determination unit 802 may be further configured to determine the word explanation corresponding to the target entity word in the target entity word set based on the text to be processed as follows: the second determination unit 802 may determine whether a target entity word corresponding to at least two word explanations exists in the target entity word set; and if exists, may extract the target entity word corresponding to at least two word explanations from the target entity word set, thereby generating a target entity word subset; and for each target entity word in the target entity word subset, the second determination unit 802 may determine a similarity between the target entity word and each word explanation of at the least two word explanations corresponding to the target entity word based on second target text, and may determine the word explanation corresponding to the target entity word based on the similarity. The second target text is text adjacent to the target entity word in the text to be processed.

In some alternative implementations, the second determination unit 802 may be further configured to determine the similarity between the target entity word and each word explanation of the at least two word explanations corresponding to the target entity word based on the second target text as follows: the second determination unit 802 may perform semantic encoding on the second target text to obtain a first semantic vector; and may perform, for each word explanation of the at least two word explanations corresponding to the target entity word, semantic encoding on the word explanation to obtain a second semantic vector, and determine a similarity between the first semantic vector and the second semantic vector as the similarity between the target entity word and the word explanation.

In some alternative implementations, the second determination unit 802 may be further configured to determine the similarity between the target entity word and each word explanation of the at least two word explanations corresponding to the target entity word based on the second target text as follows: the second determination unit 802 may extract a preset number of words adjacent to the target entity word from the text to be processed as target words; and may perform. for each word explanation of the at least two word explanations corresponding to the target entity word, coincidence matching on the word explanation and the target words, and determine a ratio of the number of coincident words to the number of the target words as the similarity between the target entity word and the word explanation.

In some alternative implementations, the second determination unit 802 may be further configured to determine the similarity between the target entity word and each word explanation of the at least two word explanations corresponding to the target entity word based on the second target text as follows: the second determination unit 802 may perform semantic encoding on the second target text to obtain a first semantic vector; then may extract a preset number of words adjacent to the target entity word from the text to be processed as target words; and then may perform, for each word explanation of the at least two word explanations corresponding to the target entity word, semantic encoding on the word explanation to obtain a second semantic vector, determine a similarity between the first semantic vector and the second semantic vector as a first similarity, perform coincidence matching on the word explanation and the target words, determine a ratio of the number of coincident words to the number of the target words as a second similarity, and perform weighted average processing on the first similarity and the second similarity to obtain the similarity between the target entity word and the word explanation.

In some alternative implementations, the apparatus 800 for processing text may further include: a deletion unit (not shown in the figure). In response to determining that the similarity between each word explanation of the at least two word explanations corresponding to the target entity word and the target entity word is smaller than a preset similarity threshold, the deletion unit may delete the target entity word from the target entity word set to obtain a new target entity word set as the target entity word set.

Reference below is made to FIG. 9, which shows a schematic structural diagram of an electronic device (for example, the server in FIG. 1) 900 suitable for implementing an embodiment of the disclosure. The electronic device shown in FIG. 9 is only illustrative, and is not intended to limit functions and a use scope of the embodiments of the disclosure.

As shown in FIG. 9, the electronic device 900 may include a processing apparatus (for example, a central processing unit or a graphics processing unit) 901, which may execute various appropriate actions and processing according to a program stored in a read only memory (ROM) 902 or a program loaded from a storage apparatus 908 to a random access memory (RAM) 903. The RAM 903 further stores various programs and data required for operations of the electronic device 900. The processing apparatus 901, the ROM 902 and the RAM 903 are connected to one another by a bus 904. An input/output (I/O) interface 905 is also connected to the bus 904.

Generally, the following apparatuses may be connected to the I/O interface 905: an input apparatus 906 including, for example, a touch screen, a touch pad, a keyboard, a mouse, a camera, a microphone, an accelerometer, a gyroscope, etc.; an output apparatus 907 including, for example, a liquid crystal display (LCD), a speaker, a vibrator, etc.; the storage apparatus 908 including, for example, a magnetic tape, a hard disk, etc.; and a communication apparatus 909. The communication apparatus 909 may allow the electronic device 900 to be in wireless or wired communication with other devices for data exchange. Although FIG. 9 shows the electronic device 900 including various apparatuses, it should be understood that not all the apparatuses shown are required to be implemented or included. More or fewer apparatuses may be alternatively implemented or included. Each block shown in FIG. 9 may represent one apparatus or a plurality of apparatuses as required.

Particularly, according to the embodiment of the disclosure, the process described above with reference to the flow diagram may be implemented to be a computer software program. For example, an embodiment of the disclosure includes a computer program product, which includes a computer program carried by a computer-readable medium. The computer program includes a program code configured to execute the method shown in the flow diagrams. In such an embodiment, the computer program may be downloaded and installed from a network through the communication apparatus 909, or installed from the storage apparatus 908, or installed from the ROM 902. The computer program executes the functions defined in the method according to the embodiment of the disclosure when being executed by the processing apparatus 901. It should be noted that the computer-readable medium according to the embodiment of the disclosure may be a computer-readable signal medium, or a computer-readable storage medium, or any combination thereof. For example, the computer-readable storage medium may be, but is not limited to, an electronic, magnetic, optical, electromagnetic, infrared, or semiconductor system, apparatus, or device, or any suitable combination thereof. More specific examples of the computer-readable storage medium may include, but are not limited to, an electrical connection having on one or more wires, a portable computer disk, a hard disk, a random access memory (RAM), a read only memory (ROM), an erasable programmable read only memory (EPROM or a flash memory), an optical fiber, a portable compact disk read only memory (CD-ROM), an optical storage device, a magnetic storage device, or any suitable combination thereof. In the embodiment of the disclosure, the computer-readable storage medium may be any tangible medium including or storing a program. The program may be used by or in combination with an instruction execution system, apparatus or device. In the embodiment of the disclosure, the computer-readable signal medium may include a data signal in a baseband or as part of a carrier for transmission, and the data signal carries a computer-readable program code. The transmitted data signal may be in various forms, which may be, but is not limited to, an electromagnetic signal, an optical signal, or any suitable combination thereof. The computer-readable signal medium may also be any computer-readable medium other than the computer-readable storage medium. The computer-readable signal medium may send, propagate or transmit a program used by or in combination with an instruction execution system, apparatus or device. The program code included in the computer-readable medium may be transmitted by any suitable medium, which may be, but is not limited to, an electric wire, an optical cable, radio frequency (RF), etc., or any suitable combination thereof.

The computer-readable medium may be included in the electronic device, or may exist independently without being assembled into the electronic device. The computer-readable medium carries one or more programs. The one or more programs when are executed by the electronic device, cause to the electronic device to: obtain the text to be processed, determine a target entity word in the text to be processed to generate the target entity word set; determine a word explanation corresponding to the target entity word in the target entity word set based on the text to be processed, and obtain the related information corresponding to the word explanation; and push the target information to present the text to be processed, and display the target entity word in the target entity word set in the preset display mode in the text to be processed, where the target information includes the target entity word set, the word explanation corresponding to the target entity word in the target entity word set, and the related information.

A computer program code configured to execute an operation of the embodiment of the disclosure may be written in one or more programming languages or a combination thereof. The programming languages include object-oriented programming languages such as Java, Smalltalk, and C++, and further include conventional procedural programming languages such as “C” or similar programming languages. The program code may be executed entirely on a user computer, executed partially on a user computer, executed as a stand-alone software package, executed partially on a user computer and partially on a remote computer, or executed entirely on the remote computer or a server. In the case involving the remote computer, the remote computer may be connected to the user computer through any type of networks including the local area network (LAN) or the wide area network (WAN), or may be connected to an external computer (for example, connected through the Internet by an Internet service provider).

The flow diagrams and block diagrams in the accompanying drawings illustrate system structures, functions and operations, which may be achieved according to systems, methods and computer program products in all the embodiments of the disclosure. In view of that, each block in the flow diagrams or block diagrams may represent a module, a program segment, or part of a code, which includes one or more executable instructions configured to implement specified logic functions. It should further be noted that in some alternative implementations, the functions noted in the blocks may also occur in an order different from that in the accompanying drawings. For example, the functions represented by two continuous blocks may be actually implemented basically in parallel, or may be implemented in reverse orders, which depends on the involved functions. It should further be noted that each block in the block diagrams and/or flow diagrams and combinations of the blocks in the block diagrams and/or the flow diagrams may be implemented with dedicated hardware-based systems that implement the specified functions or operations, or may be implemented with combinations of dedicated hardware and computer instructions.

One or more embodiments of the disclosure provide a text processing method. The method includes: obtaining text to be processed, and determining a target entity word in the text to be processed, thereby generating a target entity word set; determining a word explanation corresponding to the target entity word in the target entity word set based on the text to be processed, and obtaining related information corresponding to the word explanation; and pushing target information to present the text to be processed, and displaying the target entity word in the target entity word set in a preset display mode in the text to be processed, wherein the target information comprises the target entity word set. the word explanation corresponding to the target entity word in the target entity word set, and the related information.

According to one or more embodiments of the disclosure, determining a target entity word in the text to be processed includes: determining at least one candidate entity word in the text to be processed; and obtaining first target text, and selecting the target entity word from the at least one candidate entity word based on the first target text. The first target text is text adjacent to the text to be processed and before the text to be processed.

According to one or more embodiments of the disclosure, determining at least one candidate entity word in the text to be processed includes: performing word segmentation on the text to be processed to obtain a word segmentation result; and looking up an entity word matching the word segmentation result in a preset entity word set as the at least one candidate entity word.

According to one or more embodiments of the disclosure, determining at least one candidate entity word in the text to be processed includes: performing word segmentation on the text to be processed to obtain a word segmentation result; and for each word in the word segmentation result, obtaining a word feature of the word, inputting the word feature of the word into a pre-trained entity word recognition model, obtaining a recognition result of the word, and determining. If the recognition result indicates that the word is an entity word, the word to be a candidate entity word. The recognition result is used to indicate that the word is an entity word or to indicate that the word is not an entity word.

According to one or more embodiments of the disclosure, a presentation page of the word explanation includes a first icon and a second icon. The first icon is used to indicate that the word indicated by the word explanation is an entity word. The second icon is used to indicate that the word indicated by the word explanation is not an entity word. The method further includes: for each target entity word in the target entity word set, obtaining a number of clicks on a first icon corresponding to the target entity word and a number of clicks on a second icon corresponding to the target entity word; determining a sample category of the target entity word based on the number of clicks on the first icon corresponding to the target entity word and the number of clicks on the second icon corresponding to the target entity word, where the sample category includes a positive sample and a negative sample; and updating the entity word recognition model with a target training sample set, where a target training sample includes the target entity word in the target entity word set and the sample category of the target entity word.

According to one or more embodiments of the disclosure, selecting the target entity word from the at least one candidate entity word based on the first target text includes: for a candidate entity word in the at least one candidate entity word, determining the candidate entity word to be the target entity word in response to determining that the candidate entity word does not exist in the first target text.

According to one or more embodiments of the disclosure, the text to be processed is dialogue text. Selecting the target entity word from the at least one candidate entity word based on the first target text includes: obtaining text generation time of the first target text; determining whether duration between the current time and the text generation time is shorter than a preset duration threshold; and if so, determining, for a candidate entity word in the at least one candidate entity word, the candidate entity word to be the target entity word in response to determining that the candidate entity word does not exist in the first target text.

According to one or more embodiments of the disclosure, after determining whether the duration between the current time and the text generation time is shorter than the preset duration threshold, the method further include: if the duration is longer than or equal to the duration threshold, determine at least one candidate entity word to be the target entity word.

According to one or more embodiments of the disclosure, determining a word explanation corresponding to the target entity word in the target entity word set based on the text to be processed includes: determining whether a target entity word corresponding to at least two word explanations exists in the target entity word set; if exists, extracting the target entity word corresponding to at least two word explanations from the target entity word set, thereby generating a target entity word subset; and for each target entity word in the target entity word subset, determining a similarity between the target entity word and each word explanation of the at least two word explanations corresponding to the target entity word based on second target text, and determining the word explanation corresponding to the target entity word based on the similarity. The second target text is text adjacent to the target entity word in the text to be processed.

According to one or more embodiments of the disclosure, determining a similarity between the target entity word and each word explanation of at least two word explanations corresponding to the target entity word based on second target text includes: performing semantic encoding on the second target text to obtain a first semantic vector; and for each word explanation of the at least two word explanations corresponding to the target entity word, performing semantic encoding on the word explanation to obtain a second semantic vector, and determining a similarity between the first semantic vector and the second semantic vector as the similarity between the target entity word and the word explanation.

According to one or more embodiments of the disclosure, determining a similarity between the target entity word and each word explanation of at least two word explanations corresponding to the target entity word based on second target text includes: extracting a preset number of words adjacent to the target entity word from the text to be processed as target words; and for each word explanation of the at least two word explanations corresponding to the target entity word, performing coincidence matching on the word explanation and the target words. and determining a ratio of the number of coincident words to the number of the target words as the similarity between the target entity word and the word explanation.

According to one or more embodiments of the disclosure, determining a similarity between the target entity word and each word explanation of the at least two word explanations corresponding to the target entity word based on second target text includes the following steps: performing semantic encoding on the second target text to obtain a first semantic vector; extracting a preset number of words adjacent to the target entity word from the text to be processed as target words; and for each word explanation of the at least two word explanations corresponding to the target entity word, performing semantic encoding on the word explanation to obtain a second semantic vector, determining a similarity between the first semantic vector and the second semantic vector as a first similarity, performing coincidence matching on the word explanation and the target words, determining a ratio of the number of coincident words to the number of the target words as a second similarity, and performing weighted average processing on the first similarity and the second similarity to obtain the similarity between the target entity word and the word explanation.

According to one or more embodiments of the disclosure, after determining word explanation corresponding to the target entity word based on the similarity, the method further includes: in response to determining that the similarity between each word explanation of the at least two word explanations corresponding to the target entity word and the target entity word is smaller than a preset similarity threshold, deleting the target entity word from the target entity word set, thereby obtaining a new target entity word set as the target entity word set.

One or more embodiments of the disclosure provide a text processing apparatus. The apparatus includes: a first determination unit configured to obtain text to be processed, determine a target entity word in the text to be processed, thereby generating a target entity word set; a second determination unit configured to determine a word explanation corresponding to the target entity word in the target entity word set based on the text to be processed, and obtain related information corresponding to the word explanation; and a pushing unit configured to push target information to present the text to be processed, wherein the target information comprises the target entity word set, the word explanation corresponding to the target entity word in the target entity word set, and the related information, and display the target entity word in the target entity word set in a preset display mode in the text to be processed.

According to one or more embodiments of the disclosure, the first determination unit is further configured to determine the target entity word in the text to be processed as follows: determine at least one candidate entity word in the text to be processed; and obtain first target text, and select the target entity word from the at least one candidate entity word based on the first target text. The first target text is text adjacent to the text to be processed and before the text to be processed.

According to one or more embodiments of the disclosure, the first determination unit is further configured to determine the at least one candidate entity word in the text to be processed as follows: perform word segmentation on the text to be processed to obtain a word segmentation result; and look up an entity word matching the word segmentation result in a preset entity word set as the at least one candidate entity word.

According to one or more embodiments of the disclosure, the first determination unit is further configured to determine the at least one candidate entity word in the text to be processed as follows: perform word segmentation on the text to be processed to obtain a word segmentation result; and for each word in the word segmentation result, obtain a word feature of the word, input the word feature of the word into a pre-trained entity word recognition model, obtaining a recognition result of the word. If the recognition result indicates that the word is an entity word, determine the word to be a candidate entity word. The recognition result is used to indicate that the word is an entity word or to indicate that the word is not an entity word.

According to one or more embodiments of the disclosure, a presentation page of the word explanation includes a first icon and a second icon. The first icon is configured to indicate that the word indicated by the word explanation is an entity word. The second icon is configured to indicate that the word indicated by the word explanation is not an entity word. The apparatus further includes: an obtaining unit configured to obtain, for each target entity word in a target entity word set, a number of clicks on a first icon corresponding to the target entity word and a number of clicks on a second icon corresponding to the target entity word; a third determination unit configured to determine a sample category of the target entity word based on the number of clicks on the first icon corresponding to the target entity word and the number of clicks on the second icon corresponding to the target entity word, where the sample category comprises a positive sample and a negative sample; and an updating unit configured to update the entity word recognition model with a target training sample set, where a target training sample includes the target entity word in the target entity word set and the sample category of the target entity word.

According to one or more embodiments of the disclosure, the first determination unit is further configured to select the target entity word from the at least one candidate entity word based on the first target text as follows: for a candidate entity word in the at least one candidate entity word, determine the candidate entity word to be the target entity word in response to determining that the candidate entity word does not exist in the first target text.

According to one or more embodiments of the disclosure, the text to be processed is dialogue text. The first determination unit is further configured to select the target entity word from the at least one candidate entity word based on the first target text as follows: obtain text generation time of the first target text; determine whether duration between the current time and the text generation time is shorter than a preset duration threshold; and if so, for a candidate entity word in the at least one candidate entity word, determine the candidate entity word to be the target entity word in response to determining that the candidate entity word does not exist in the first target text.

According to one or more embodiments of the disclosure, the apparatus further includes: a fourth determination unit configured to determine, if the duration is longer than or equal to the duration threshold, the at least one candidate entity word to be the target entity word.

According to one or more embodiments of the disclosure, the second determination unit is further configured to determine the word explanation corresponding to the target entity word in the target entity word set based on the text to be processed as follows: determine whether a target entity word corresponding to at least two word explanations exists in the target entity word set; if exists, extract the target entity word corresponding to at least two word explanations from the target entity word set, thereby generating a target entity word subset; and for each target entity word in the target entity word subset, determine a similarity between the target entity word and each word explanation of the at least two word explanations corresponding to the target entity word based on second target text, and determine the word explanation corresponding to the target entity word based on the similarity. The second target text is text adjacent to the target entity word in the text to be processed.

According to one or more embodiments of the disclosure, the second determination unit is further configured to determine the similarity between the target entity word and each word explanation of the at least two word explanations corresponding to the target entity word based on the second target text as follows: perform semantic encoding on the second target text to obtain a first semantic vector; and for each word explanation of the at least two word explanations corresponding to the target entity word, perform semantic encoding on the word explanation to obtain a second semantic vector, and determine a similarity between the first semantic vector and the second semantic vector as the similarity between the target entity word and the word explanation.

According to one or more embodiments of the disclosure, the second determination unit is further configured to determine the similarity between the target entity word and each word explanation of the at least two word explanations corresponding to the target entity word based on the second target text as follows: extract a preset number of words adjacent to the target entity word from the text to be processed as target words; and for each word explanation of the at least two word explanations corresponding to the target entity word, perform coincidence matching on the word explanation and the target words, and determine a ratio of the number of coincident words to the number of the target words as the similarity between the target entity word and the word explanation.

According to one or more embodiments of the disclosure, the second determination unit is further configured to determine the similarity between the target entity word and each word explanation of the at least two word explanations corresponding to the target entity word based on the second target text as follows: perform semantic encoding on the second target text to obtain a first semantic vector; extract a preset number of words adjacent to the target entity word from the text to be processed as target words; and for each word explanation of the at least two word explanations corresponding to the target entity word, perform semantic encoding on the word explanation to obtain a second semantic vector, determine a similarity between the first semantic vector and the second semantic vector as a first similarity, perform coincidence matching on the word explanation and the target words, determine a ratio of the number of coincident words to the number of the target words as a second similarity, and perform weighted average processing on the first similarity and the second similarity to obtain the similarity between the target entity word and the word explanation.

According to one or more embodiments of the disclosure, the apparatus further includes: a deletion unit configured to delete, in response to determining that the similarity between each word explanation of the at least two word explanations corresponding to the target entity word and the target entity word is smaller than a preset similarity threshold, the target entity word from target entity word set, thereby obtaining a new target entity word set as the target entity word set.

The units involved in the embodiments described in the disclosure may be implemented by software or hardware. The described units may also be arranged in a processor, and for example, may be described as follows: a processor includes a first determination unit, a second determination unit, and a pushing unit. Names of the units do not limit the units themselves in some cases. For example, the first determination unit may also be described as “a unit configured to obtain text to be processed, determine a target entity word in the text to be processed, thereby generating a target entity word set”.

What are described above are merely illustrative of preferred embodiments of the disclosure and principles of the technology employed. It should be understood by those skilled in the art that the scope of the inventions involved in the embodiments of the disclosure is not limited to the technical solution formed by a specific combination of the above-mentioned technical features, and should also cover other technical solutions formed by any combination of the above-mentioned technical features or equivalent features without departing from the inventive concept, for example, the technical solution formed by interchanging the features with (non-limitative) technical features having similar functions disclosed in the embodiments of the disclosure.

1. A text processing method, comprising:
obtaining text to be processed, and determining a target entity word in the text to be processed, thereby generating a target entity word set;
determining a word explanation corresponding to the target entity word in the target entity word set based on the text to be processed, and obtaining related information corresponding to the word explanation; and
pushing target information to present the text to be processed, and displaying the target entity word in the target entity word set in a preset display mode in the text to be processed, wherein the target information comprises the target entity word set, the word explanation corresponding to the target entity word in the target entity word set, and the related information.

2. The method according to claim 1, wherein the determining a target entity word in the text to be processed comprises:
determining at least one candidate entity word in the text to be processed; and
obtaining first target text, and selecting the target entity word from the at least one candidate entity word based on the first target text, wherein the first target text is text adjacent to the text to be processed and before the text to be processed.

3. The method according to claim 2, wherein the determining at least one candidate entity word in the text to be processed comprises:
performing word segmentation on the text to be processed to obtain a word segmentation result; and
looking up an entity word matching the word segmentation result in a preset entity word set as the at least one candidate entity word.

4. The method according to claim 2, wherein the determining at least one candidate entity word in the text to be processed comprises:
performing word segmentation on the text to be processed to obtain a word segmentation result; and
obtaining, for each word in the word segmentation result, a word feature of the word, inputting the word feature of the word into a pre-trained entity word recognition model, obtaining a recognition result of the word, and determining, if the recognition result indicates that the word is an entity word, the word to be a candidate entity word, wherein the recognition result is used to indicate that the word is an entity word or to indicate that the word is not an entity word.

5. The method according to claim 4, wherein a presentation page of the word explanation comprises a first icon and a second icon, wherein the first icon is used to indicate that the word indicated by the word explanation is an entity word, and the second icon is used to indicate that the word indicated by the word explanation is not an entity word; and
the method further comprises:
obtaining, for each target entity word in the target entity word set, a number of clicks on a first icon corresponding to the target entity word and a number of clicks on a second icon corresponding to the target entity word;
determining a sample category of the target entity word based on the number of clicks on the first icon corresponding to the target entity word and the number of clicks on the second icon corresponding to the target entity word, wherein the sample category comprises a positive sample and a negative sample; and
updating the entity word recognition model with a target training sample set, wherein a target training sample comprises the target entity word in the target entity word set and the sample category of the target entity word.

6. The method according to claim 2, wherein the selecting the target entity word from the at least one candidate entity word based on the first target text comprises:
determining, for a candidate entity word in the at least one candidate entity word, the candidate entity word to be the target entity word in response to determining that the candidate entity word does not exist in the first target text.

7. The method according to claim 2, wherein the text to be processed is dialogue text; and
the selecting the target entity word from the at least one candidate entity word based on the first target text comprises:
obtaining text generation time of the first target text;
determining whether duration between the current time and the text generation time is shorter than a preset duration threshold; and
if so, determining, for a candidate entity word in the at least one candidate entity word, the candidate entity word to be the target entity word in response to determining that the candidate entity word does not exist in the first target text.

8. The method according to claim 7, wherein after the determining whether duration between the current time and the text generation time is shorter than a preset duration threshold, the method further comprises:
determining, if the duration is longer than or equal to the duration threshold, the at least one candidate entity word to be the target entity word.

9. The method according to claim 1, wherein the determining a word explanation corresponding to the target entity word in the target entity word set based on the text to be processed comprises:
determining whether a target entity word corresponding to at least two word explanations exists in the target entity word set;
if exists, extracting the target entity word corresponding to at least two word explanations from the target entity word set, thereby generating a target entity word subset; and
determining, for each target entity word in the target entity word subset, a similarity between the target entity word and each word explanation of the at least two word explanations corresponding to the target entity word based on second target text, and determining the word explanation corresponding to the target entity word based on the similarity, wherein the second target text is text adjacent to the target entity word in the text to be processed.

10. The method according to claim 9, wherein the determining a similarity between the target entity word and each word explanation of at least two word explanations corresponding to the target entity word based on second target text comprises:
performing semantic encoding on the second target text to obtain a first semantic vector; and
performing, for each word explanation of the at least two word explanations corresponding to the target entity word, semantic encoding on the word explanation to obtain a second semantic vector, and determining a similarity between the first semantic vector and the second semantic vector as the similarity between the target entity word and the word explanation.

11. The method according to claim 9, wherein the determining a similarity between the target entity word and each word explanation of at least two word explanations corresponding to the target entity word based on second target text comprises:
extracting a preset number of words adjacent to the target entity word from the text to be processed as target words; and
performing, for each word explanation of the at least two word explanations corresponding to the target entity word, coincidence matching on the word explanation and the target words, and determining a ratio of the number of coincident words to the number of the target words as the similarity between the target entity word and the word explanation.

12. The method according to claim 9, wherein the determining a similarity between the target entity word and each word explanation of the at least two word explanations corresponding to the target entity word based on second target text comprises:
performing semantic encoding on the second target text to obtain a first semantic vector;
extracting a preset number of words adjacent to the target entity word from the text to be processed as target words; and
performing, for each word explanation of the at least two word explanations corresponding to the target entity word, semantic encoding on the word explanation to obtain a second semantic vector, determining a similarity between the first semantic vector and the second semantic vector as a first similarity, performing coincidence matching on the word explanation and the target words, determining a ratio of the number of coincident words to the number of the target words as a second similarity, and performing weighted average processing on the first similarity and the second similarity to obtain the similarity between the target entity word and the word explanation.

13. The method according to claim 9, wherein after the determining the word explanation corresponding to the target entity word based on the similarity, the method further comprises:
deleting, in response to determining that the similarity between each word explanation of the at least two word explanations corresponding to the target entity word and the target entity word is smaller than a preset similarity threshold, the target entity word from the target entity word set, thereby obtaining a new target entity word set as the target entity word set.

14. (canceled)

15. An electronic device, comprising:
one or more processors; and
a storage apparatus storing one or more programs, wherein
the one or more programs, when executed by the one or more processors, cause the one or more processors to:
obtain text to be processed, and determine a target entity word in the text to be processed, thereby generating a target entity word set;
determine a word explanation corresponding to the target entity word in the target entity word set based on the text to be processed, and obtain related information corresponding to the word explanation; and
push target information to present the text to be processed, and display the target entity word in the target entity word set in a preset display mode in the text to be processed, wherein the target information comprises the target entity word set, the word explanation corresponding to the target entity word in the target entity word set, and the related information.

16. A computer-readable medium, storing a computer program, wherein the computer program, when executed by a processor, causes the processor to:
obtain text to be processed, and determine a target entity word in the text to be processed, thereby generating a target entity word set;
determine a word explanation corresponding to the target entity word in the target entity word set based on the text to be processed, and obtain related information corresponding to the word explanation; and
push target information to present the text to be processed, and display the target entity word in the target entity word set in a preset display mode in the text to be processed, wherein the target information comprises the target entity word set, the word explanation corresponding to the target entity word in the target entity word set, and the related information.

17. The electronic device according to claim 15, wherein the computer program, when causing the processor to determine a target entity word in the text to be processed, causes the processor to:
determine at least one candidate entity word in the text to be processed; and
obtain first target text, and select the target entity word from the at least one candidate entity word based on the first target text, wherein the first target text is text adjacent to the text to be processed and before the text to be processed.

18. The electronic device according to claim 17, wherein the computer program, when causing the processor to determine at least one candidate entity word in the text to be processed, causes the processor to:
perform word segmentation on the text to be processed to obtain a word segmentation result; and
look up an entity word matching the word segmentation result in a preset entity word set as the at least one candidate entity word.

19. The electronic device according to claim 17, wherein the computer program, when causing the processor to determine at least one candidate entity word in the text to be processed, causes the processor to:
perform word segmentation on the text to be processed to obtain a word segmentation result; and
obtain, for each word in the word segmentation result, a word feature of the word, input the word feature of the word into a pre-trained entity word recognition model, obtaining a recognition result of the word, and determine, if the recognition result indicates that the word is an entity word, the word to be a candidate entity word, wherein the recognition result is used to indicate that the word is an entity word or to indicate that the word is not an entity word.

20. The electronic device according to claim 19, wherein a presentation page of the word explanation comprises a first icon and a second icon, wherein the first icon is used to indicate that the word indicated by the word explanation is an entity word, and the second icon is used to indicate that the word indicated by the word explanation is not an entity word; and
wherein the computer program, when executed by the processor, further causes the processor to:
obtain, for each target entity word in the target entity word set, a number of clicks on a first icon corresponding to the target entity word and a number of clicks on a second icon corresponding to the target entity word;
determine a sample category of the target entity word based on the number of clicks on the first icon corresponding to the target entity word and the number of clicks on the second icon corresponding to the target entity word, wherein the sample category comprises a positive sample and a negative sample; and
update the entity word recognition model with a target training sample set, wherein a target training sample comprises the target entity word in the target entity word set and the sample category of the target entity word.

21. The electronic device according to claim 17, wherein the computer program, when causing the processor to select the target entity word from the at least one candidate entity word based on the first target text, causes the processor to:
determine, for a candidate entity word in the at least one candidate entity word, the candidate entity word to be the target entity word in response to determining that the candidate entity word does not exist in the first target text.
